(19) United States
(12) Patent Application Publication
(10) Pub. No.: US 2010/0025179 A1
(43) Pub. Date: Feb. 4, 2010

(54) MOUNTING BASE APPARATUS

(76) Inventor: Mark Behrens, Warwick, NY (US)

Correspondence Address: ADAMS INTELLECTUAL PROPERTY LAW, Suite 2350 Charlotte Plaza, 201 South College Street, CHARLOTTE, NC, 28244, US

(21) Appl. No.: 11/813,567

(22) PCT Filed: Jul. 6, 2007
(86) PCT No.: PCT/US07/72973

§ 371 Date: Jul. 9, 2007

Related U.S. Application Data
(60) Provisional application No. 60/818,765, filed on Jul. 6, 2006.
(60) Provisional application No. 60/851,868, filed on Oct. 13, 2006.

(51) Int. Cl. F16D 13/16; F16M 13/00

(52) U.S. Cl. 192/76; 248/674

(57) ABSTRACT

A mounting base apparatus can be attached semi permanently to the base of a small engine, or built into the base of the engine, or into an implement of power equipment. This mounting device engages a singular point or a plurality of points provided for this purpose, to allow quick disconnection of the engine, so that the engine may be used on other implements conveniently. Because a single engine is to be used on various implements, provision is also made (on each implement) to support the rotating (work piece or transmission shaft) via an auxiliary spindle assembly on the implement in the absence of an engine. Further, provision is made to transmit torque from the engine through this auxiliary spindle shaft via a flexible coupling arrangement. Further, provision is made to transmit the motion (generally push-pull) of the throttle cable, where applicable, to the engine, also in a quick-disconnect manner. Where applicable, provision is made for a handle to comfortably lift the hot engine from one implement to another.

### TECHNICAL FIELD OF THE INVENTION

This application claims priority to U.S. Provisional Application No. 60/818,765, filed Jul. 6, 2006, and U.S. Provisional Application No. 60/851,868, filed Oct. 13, 2006. The invention relates to engine mounting and also to mounting electric motors to equipment. One embodiment of the invention includes a mounting base apparatus particularly suited for small engines that allows for a single engine to be used with multiple power implements, such as outdoor power equipment.

### BACKGROUND OF THE INVENTION

Small motor engines have typically been mounted directly to outdoor power equipment (OPE) implements with nuts and bolts, as shown in FIG. 6. Such a mounting is semi-permanent and rigidly fixes the engine, via these nuts and bolts, through holes in the engine base that align with holes in the implement's mounting plate. In such a configuration, the engine often becomes part of the actual machine structure because the implement housing or some element of its frame or transmission (if applicable) is bolted onto the engine's mounting flange boss, which is provided for this purpose. The engine end of the throttle cable, where applicable, is typically fixed by geometry and a screwed-on-clamp to the throttle of the engine. If the working implement (that is, the primary driven member) is a cutter, blade, impellor, etc. it would typically be mounted directly onto the engine output shaft and fixed in place with one or more set screws.

The combination of these multiple attachments to the engine result in the engine being rigidly attached to the implement, and not easily or quickly detached. If during the life of the engine, it must be detached—this would require execution of a difficult removal procedure, generally by a technician, using specific hand tools. Because such a removal is very time consuming and labor intensive, it is generally done only in the circumstance of a severe engine problem, and not for routine servicing of the engine.

Because engine removal is generally time consuming and inconvenient, one engine is generally not swapped onto a different power implement during the course of normal operation. The general practice is that each implement of outdoor power equipment (OPE) has its own engine attached to it for the life of the engine or the implement. This means that, for example, for four OPE implements such as a chipper-shredder, a snow thrower, a leaf blower, and a pressure washer—four small engines would be required.

### SUMMARY OF THE INVENTION

Therefore, it is an object of the present invention to provide a mounting apparatus that allows a motor such as a small engine to be easily disconnected from one implement and mounted to another.

Another object of the present invention is to provide a method for using one engine on multiple power implements.

These and other objects of the present invention can be achieved in the preferred embodiments of the invention described below. One preferred embodiment of the invention includes a mounting apparatus for supporting a motor and releasably attaching to a power implement, the mounting apparatus having at least one support plate for receiving the motor thereon that is movably connected to at least one latching member. A connecting plate is connected to the support plate and has at least one opening for receiving a power implement connecting member and the latching member therethrough. A slider plate is movably connected to the latching member and is adapted for sliding movement relative to the support plate such that the slider plate can move between a locked position, in which the latching member engages the power implement connecting member to connect the mounting apparatus to the power implement, and an open position, in which the latching member is disengaged from the power implement connecting member and the mounting apparatus is removeable from the power implement.

According to another preferred embodiment of the invention, the mounting apparatus includes restoring means for returning the slider plate from the open position to the locked position.

According to another preferred embodiment of the invention, the restoring means is a spring contacting the connecting plate that is positioned within an opening of the connecting plate. The spring is in further in contact with a stop pin attached to the slider plate.

According to another preferred embodiment of the invention, the mounting apparatus includes securing means for releasably securing the slider plate in the open position.

According to another preferred embodiment of the invention, the securing means includes a locking pin inserted through at least one opening on the slider plate and at least one opening on the connecting plate.

According to another preferred embodiment of the invention, the mounting apparatus includes interrupting means for interrupting the motor when the slider plate is not in the locked position.

According to another preferred embodiment of the invention, the interrupting means includes a limit switch attached to the connecting plate and electrically connected to the motor.

According to another preferred embodiment of the invention, the power implement connecting member includes a mounting plate attached to the power implement that is capable of receiving the mounting apparatus thereon.

According to another preferred embodiment of the invention, the support plate is pivotally connected to the latching member, and the slider plate is pivotally connected to the latching member.

According to another preferred embodiment of the invention, the latching member includes a slot and is adapted for sliding movement relative to the support plate.

According to another preferred embodiment of the invention, a mounting apparatus for supporting a motor and releasably attaching to a power implement includes a first outer plate for receiving the motor thereon, and at least one support plate connected to the first outside plate that is moveably connected to at least one latching member. A connecting plate is connected to the support plate and has at least one opening for receiving a power implement connecting member and the latching member therethrough. A slider plate is movably connected to at least one latching member and adapted for sliding movement relative to the support plate such that the slider plate can move between a locked position, in which the latching member engages the power implement connecting member to connect the mounting apparatus to the power implement, and an open position, in which the latching member is disengaged from the power implement connecting member and the mounting apparatus is removeable from the power implement. A second outer plate is connected to the connecting plate and has at least one opening substantially aligned with the opening of the connecting plate for receiving the power implement connecting member therethrough.

According to another preferred embodiment of the invention, the mounting apparatus includes securing means for releasably securing the slider plate in the open position.

According to another preferred embodiment of the invention, the mounting apparatus includes interrupting means for interrupting the motor when the slider plate is not in the locked position.

According to another preferred embodiment of the invention, the latching member has a slot and is adapted for sliding movement relative to the support plate.

According to another preferred embodiment of the invention, a mounting apparatus for releasably securing a motor to a power implement includes a support plate for receiving the motor thereon having at least one interlocking member. A mounting plate is connected to the power implement and has complementary interlocking means for engaging the interlocking member of the support plate to releasably secure the support plate to the mounting plate.

According to another preferred embodiment of the invention, a tapered edge of the support plate is adapted to mate with a complementary tapered edge of the mounting plate when the support plate is releasably secured to the mounting plate.

According to another preferred embodiment of the invention, a concave edge of the support plate is adapted to mate with a complementary convex edge of the mounting plate when the support plate is releasably secured to the mounting plate.

According to another preferred embodiment of the invention, the interlocking member includes at least one latching member, and the complementary interlocking means includes at least one complementary latching member adapted to receive and releasably secure at least one latching member.

According to another preferred embodiment of the invention, the support plate and the mounting plate are shaped for complementary engagement.

According to another preferred embodiment of the invention, the interlocking member includes a plurality of fingers extending downwardly from the support plate, and the complementary interlocking means includes a plurality of recesses for receiving the fingers, such that engagement of the fingers in the recesses connects the support plate to the mounting plate.

According to another preferred embodiment of the invention, the interlocking member includes a first opening, and the complementary interlocking means includes a lower section mounted on the mounting plate and an upper section extending above the lower section and having a second opening for aligning with the first opening. The interlocking member is positioned below the upper section such that a fastener can be positioned through the first and second openings to attach the support plate to the mounting plate.

According to another preferred embodiment of the invention, the support plate has a perimeter defining a distinct shape, and the interlocking means includes a platform mounted on the mounting plate having an opening defining a shape substantially similar to the shape of the support plate perimeter for receiving the support plate therein and maintaining the support plate in a stationary position.

According to another preferred embodiment of the invention, the interlocking means includes a fastening member mounted on the mounting plate and the interlocking member includes an opening proximate to the perimeter of the support plate for receiving the fastening member therethrough.

According to another preferred embodiment of the invention, a clutch assembly for use with an engine and a power implement includes an engine output shaft operatively connected to the engine, a clutch hub mounted on the engine output shaft, and an intermediate shaft operatively connected to the power implement. A clutch drum is connected to the intermediate shaft and operatively connected to the clutch hub. The engine output shaft is disconnected from the intermediate shaft such that the power implement is removable from the engine output shaft.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is an exploded, perspective view of a mounting base apparatus according to a preferred embodiment of the invention;

FIG. 2 is a top view of the mounting base apparatus of FIG. 1 in the open position, in which it is ready to mount an engine to an implement;

FIG. 3 is the mounting base apparatus of FIG. 1 in the closed position, in which an engine is fastened to an implement;

FIG. 4 is another perspective view of the mounting base apparatus of FIG. 1;

FIG. 5 is an environmental perspective view of the mounting base apparatus of FIG. 1;

FIG. 6 is a perspective view of the prior art;

FIG. 7 is an exploded perspective view of a mounting base apparatus according to another preferred embodiment of the invention;

FIG. 8 is a perspective view of the mounting base apparatus of FIG. 7 in the engine-mounted position.

FIG. 9 is a partially exploded perspective view of a mounting base apparatus according to another preferred embodiment of the invention;

FIG. 9A is a partial cross sectional view of the mounting base apparatus of FIG. 9;

FIG. 9B is a top perspective view of a mounting base apparatus according to another preferred embodiment of the invention;

FIG. 9C is a bottom perspective view of the mounting base apparatus of FIG. 9B;

FIG. 10 is an exploded perspective view of the mounting base apparatus of FIG. 9 installed into the functional blocks of a power shifter assembly and implement assembly; illustrating the interface of the power shifter assembly and the implement assembly;

FIG. 10A is a partial cross sectional view of the mounting base apparatus of FIG. 9; (Is there any need to indicate 10A, B, and C are variants?)

FIG. 10B is another partial cross sectional view of the mounting base apparatus of FIG. 9;

FIG. 10C is another partial cross sectional view of the mounting base of FIG. 9;

FIG. 11 is a perspective view of a mounting base apparatus according to another preferred embodiment of the invention.

FIG. 12 is an exploded perspective view of the mounting base apparatus of FIG. 11;

FIG. 12A is a partial perspective view of the mounting base apparatus of FIG. 11;

FIG. 13 is a partially exploded perspective view of a mounting base apparatus according to another preferred embodiment of the invention;

FIG. 14 is a exploded perspective view of a clutch apparatus according to another preferred embodiment of the invention; and

FIG. 15 is an environmental cross sectional view of the clutch apparatus of FIG. 14.

### REFERENCE NUMERALS

10—mounting base apparatus
70—mounting base apparatus
90—mounting base apparatus
100—top plate
102—support plate
103—stop pin
104—connecting plate
106—bottom plate
108—limit switch
110—slider plate return spring
112—locking pin
113—dowel pin
114—slider plate
117—link [120 open hole in conn. plate]
118—assembly screw [122 closed hole]
200—assembly holes
202—engine mounting bolt holes
204—recess for head of an implement-mounting stud (not shown)
206—recess for body of an implement-mounting stud (not shown)
208—recess for link motion
212—operator handle
300—locking pin hole for closed position
302—body of implement-mounting stud (516) abbreviated IMS
400—recess for head of IMS in bottom plate
402—recess for head of IMS in connecting plate
404—recess for head of IMS in slider plate
406—recess for body of IMS
500—implement assembly
502—engine
503—implement engine mounting plate
504—blower housing
506—blower impellor blade
508A—engine side of flexible coupling
508B—implement side of flexible coupling
510—rubber element of flexible coupling
512—auxiliary spindle assembly
514—engine mounting bolts
516—implement-mounting studs
518—angle brackets
520—auxiliary spindle assembly
522—setscrew
525—Power Shifter Assembly
600—flange mounting boss
602—flange mounting bolts
604—engine output shaft
608—blower housing cover
702A—forward mount brackets
702B—rearward mount brackets
706—recess for ball detent
708A—hole for locking pin
708B—hole for locking pin
710—recess to clear rearward mount bracket 702B
712—stop mount bracket
714—mount bracket bolts
716—ball detents
725—power shifter assembly
901—engine support plate
902—base mounting plate
903a—latch catch mounting bolts
903b—latch
904—limit
905—bolt to mount engine
906—bolt to attach mounting plate 902
1000—power shifter assembly
1002—implement assembly
1003a—coupling half, implement side
1003b—coupling half plus spider, engine side
1100—power shifter assembly
1101—engine support plate
1102—implement assembly
1104—retaining plate
1106—pivot pin
1111—pivot hole
1205a—contoured recess in retaining plate 1104
1205b—contour of engine support plate
1206—spacer for retaining plate
1207—bolt to fasten retaining plate
1208—thumbscrew
1209—bolt for mounting engine
1210—spacer for engine
1212—holes for thumbscrew 1208
1220—interference area
1222—engine mounting holes
1301—enging mounting plate
1302—implement engine mounting plate
1303—shaped finger(s)
1304—aligning slot
1305—locking hole
1307—aligning pin
1308—recess for shaped fingers
1401—clutch center hub
1402—clutch drive plate
1402a—drive tab
1402b—hook profile
1403—clutch shoe with hook profile
1403a—specially formed recess
1403b—garter spring slot
1404—clutch garter spring
1405—clutch closing disk
1406—clutch snap ring
1407—clutch retaining pin
1408—clutch drum
1501—engine output shaft
1502—auxiliary spindle
1503—intermediate shaft
1504—belt pulley

### DEFINITIONS AND TERMS

“Semi-permanent” as used herein refers to a connection that can be detached in an extensive, service operation, but typically is not detached during the normal operation of the engine or implement.

“Quick-Disconnect” (QD) as used herein refers to an attachment that can be disconnected by hand, without the use of tools. As such, it is designed for use during the normal operation of the equipment.

As an example of both, consider a conventional passenger automobile door. The door latch is used to quickly open the door for entry and egress from the vehicle, and is an example of a quick-disconnect attachment of the door member to the structure of the vehicle. Conversely, the door hinge on the other end of said door requires tools to disconnect, and is an example of semi-permanent mounting.

“Permanent” mounting refers to a connection, such as the welding of two metal parts, in which separation would require destructive means, such as grinding or cutting.

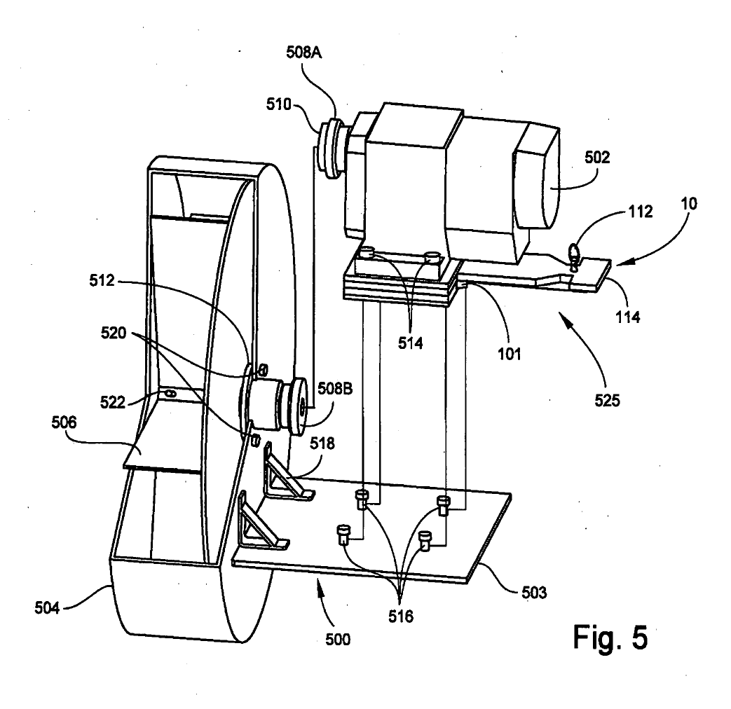

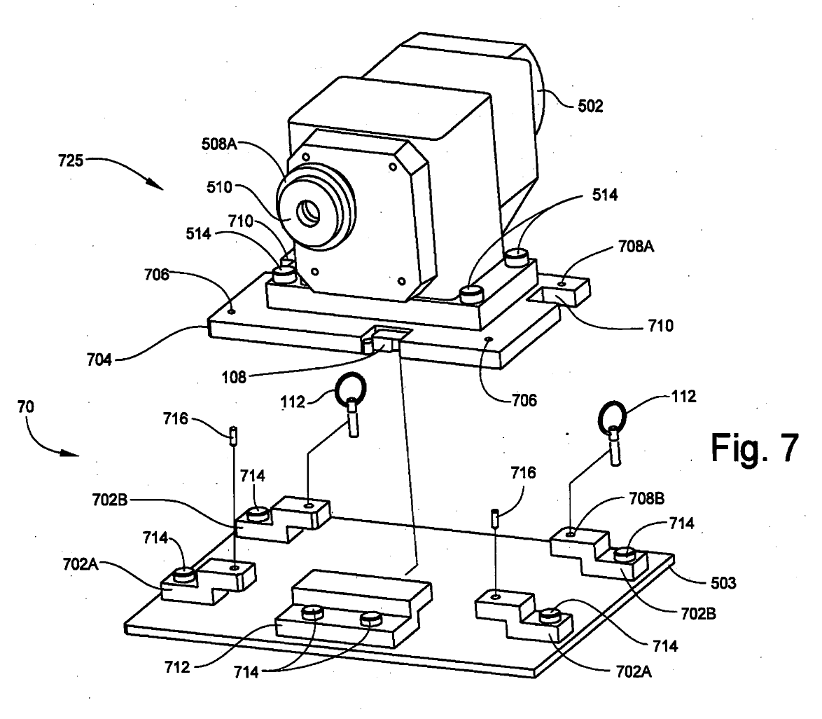

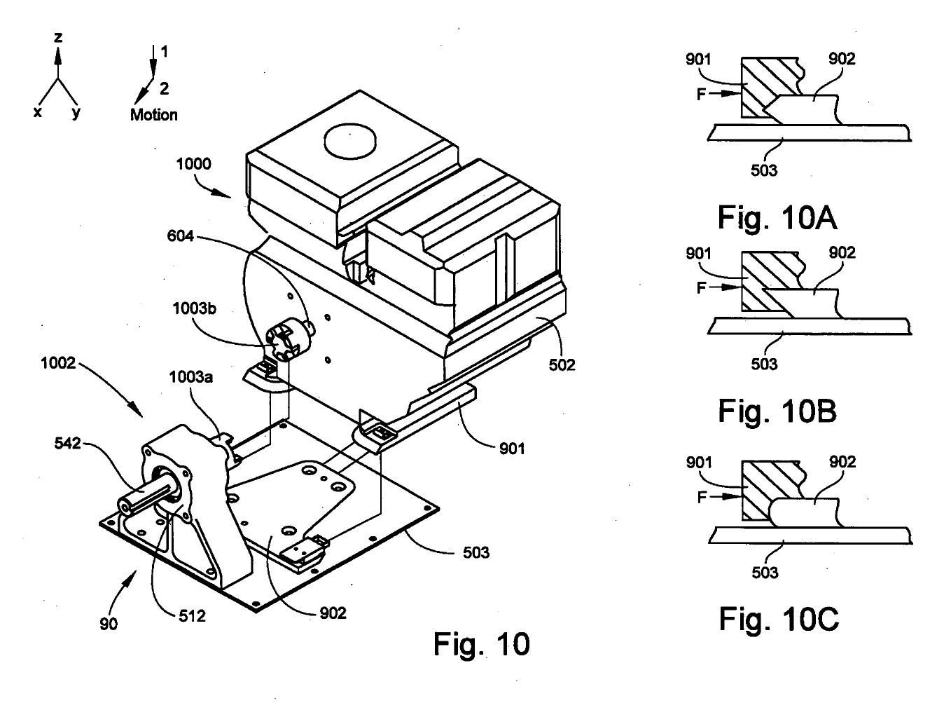

“Power Shifter Assembly” refers to an assembly comprised of an engine, a mounting base apparatus, and any requisite (engine-side) torque-transmitting elements such as is shown at reference numerals 510 and 508A in FIGS. 5, and 7, or reference numerals 1003a and 1003b in FIGS. 10, 11 and 12.

“Implement Assembly” refers generally to any implement that can be used with a mounting base apparatus of the invention, and may include items such as implement-mounting bolts 516, auxiliary spindle assembly 512, and torque transmitting element 508B along with the balance of the implement and its hardware, as illustrated in FIG. 5.

### DESCRIPTION OF PRIOR ART

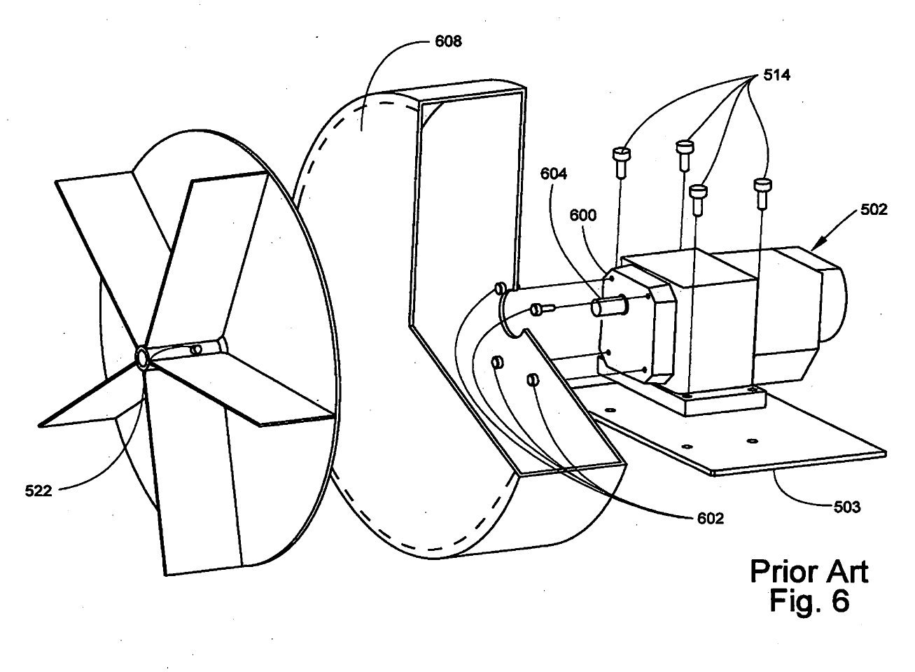

FIG. 6 illustrates a prior art method of semi-permanently attaching an engine 502 to the implement engine mounting plate 503 with engine mounting bolts 514. Once the engine 502 is rigidly mounted in this manner, the implement-mounting boss 600 becomes a strong, structural mounting element to which parts of the implement, such as a blower housing 504 may be bolted, with housing mounting bolts 602. The presence of an implement-mounting boss 600 is commonplace in the prior art and on the small engines relevant to this invention, and often comprises an integral part of mechanical attachment for an implement assembly. Once the blower housing 504 is bolted in place, blower impellor blade 506 is slid onto engine output shaft 604, and held in place with setscrew 522. Finally, a cover plate 608 is attached with bolts or screws (not shown) to complete the assembly.

### DETAILED DESCRIPTION OF THE PREFERRED EMBODIMENTS AND BEST MODE OF THE INVENTION

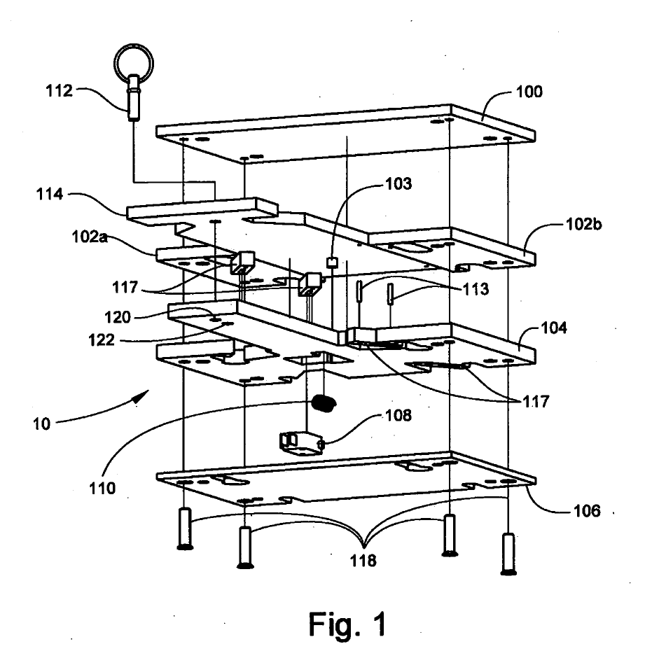

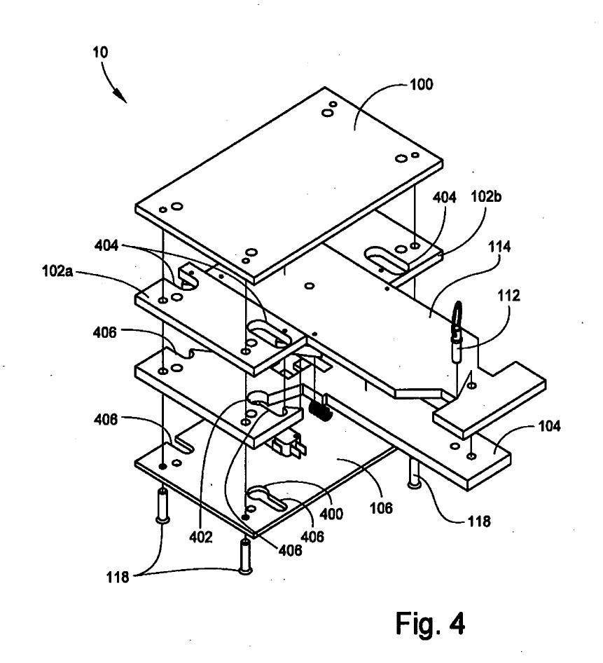

A mounting base apparatus according to a preferred embodiment of the invention is illustrated in FIGS. 1-5, and shown generally at reference numeral 10. As shown in FIG. 1, the combined requirements of a captive assembly and operating linkage are achieved by a stacked assembly of four layers of plates with special geometry, and ancillary components. One advantage of the mounting base apparatus 10 is its compact space—that is, the small “footprint” with respect to the engine-mounting base that is required. The material for all components of the mounting base apparatus 10, with the exception of a limit switch 108, may be steel or other suitable material. (See FIG. 4 also for layer references.) The first layer, which is the upper most layer, comprises a top plate 100 that comes into direct contact with a motor such as an engine.

The second layer is comprised of two support plates 102a, 102b, each mirror images, which flank a slider plate 114 that is slightly thinner than support plates 102a and 102b to provide sliding clearance. Four dowel pins 113 and a stop pin 103 are pressed into the slider plate 114 with an interference fit. Two more dowel pins 113 are pressed into each support plate 102a, 102b with an interference fit, for a total of eight dowel pins 113.

The third layer is comprised of a connecting plate 104 and four connecting members such as links 117. Each link 117 fits into a recess in the connecting plate 104, these recesses being large enough to allow the links to move freely in their required travel. Each link 117 is also engaged (with clearance fit) by two dowel pins 113. These dowel pins protrude down into the connecting plate 104 from the slider plate 114. One of these two dowel pins 113 becomes a pivot point for link 117, the other slides in a slot in the link 117. In each case, the pivot point dowel pin is attached by press-fit into the slider plateslider 114, and the sliding contact dowel pin is attached by press-fit into the support plate 102. A slider plate return spring 110 is bounded on one end and two sides by a recess in the connecting plate 104, and at the other end by the stop pin 103. In a recess adjacent to the return spring 110 is the limit switch 108, which is acted upon by the stop pin 103, and wired into the ignition system of the engine (not shown).

The fourth layer is comprised of a bottom plate 106, which comes into contact with an engine mounting plate of a power implement (not shown). The mounting base apparatus 10 is held together by four assembly screws 118, which run upwardly through clearance holes in the plates 106, 104, and 102 respectively, and engage threaded holes in top plate 100. In operation, a removable locking pin 112 simultaneously engages a hole 300 in the slider plate 114 and either of two holes 120, 122 in the connecting plate 104. One hole 120 is positioned to hold the mounting base apparatus 10 in the “open” position against the force which the slider plate return spring 110 exerts against the stop pin 103. The other hole 122 in the connecting plate 104 is positioned to hold the mounting base apparatus 10 securely in the “closed” position.

The top plate 100 is about the size (in length and width) of the mounting base of the engine, or perhaps slightly larger. The top surface of the top plate 100 and the bottom surface of the bottom plate 106 are preferably smooth, because the assembly screws 118 are flush with (or below) these surfaces. The combined thickness of the plates 100, 102, 104, 106 may be approximately ½″ to 1½″ as required.

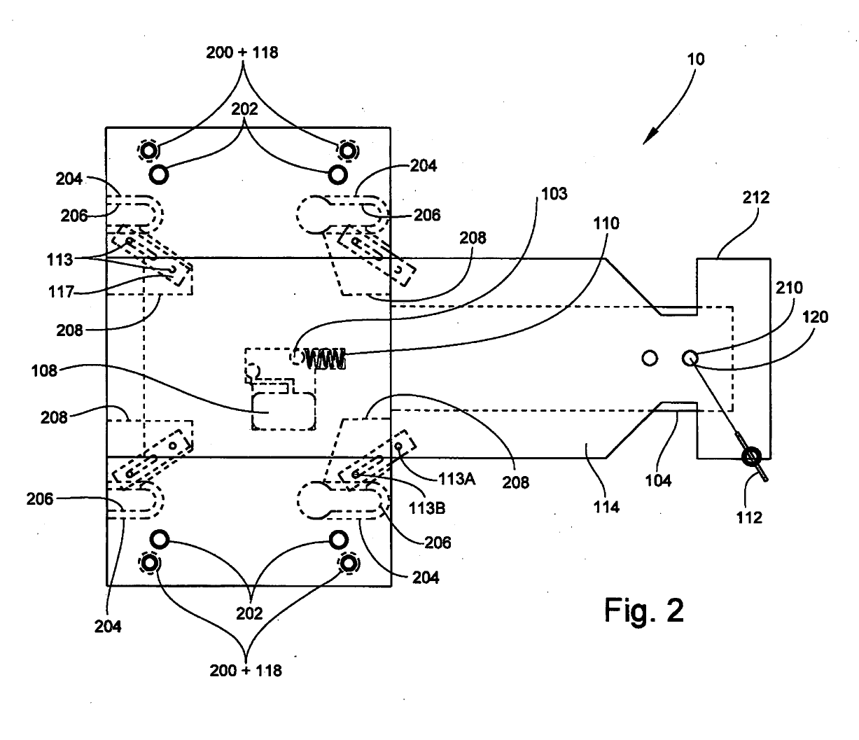

The mounting base apparatus 10 is shown in FIG. 2 in the open position, in which the locking pin 112 engages two adjacent holes 300 in the slider plate 114 and the hole 120 in the connecting plate 104. The locking pin 112 is equipped with a detent to ensure it remains in position despite shock and vibration. Operator handle 212 allows for a good grip for the operator in manipulating the slider plate 114. A recess for the head of an implement-mounting stud (not shown) is shown in FIG. 2 at reference numeral 204, and a recess for the body of said implement-mounting stud is shown at reference numeral 206. The limit switch 108 is disengaged from stop pin 103, which is shown compressing slider plate return spring 110. This position of the limit switch 108 would open (or close) an electrical circuit to stop the engine (not shown). Each of the four links 117 is shown engaged by the dowel pins 113.

FIG. 2 illustrates the configuration of the four inboard dowel pins 113A pressed into the slider plate 114, and the four outboard dowel pins 113B pressed into the support plate 102a. Assembly holes 200 are shown with assembly screws 118. Engine mounting holes 202 engage engine mounting bolts (not shown) which are used to mount the engine (not shown) to the mounting base apparatus 10.

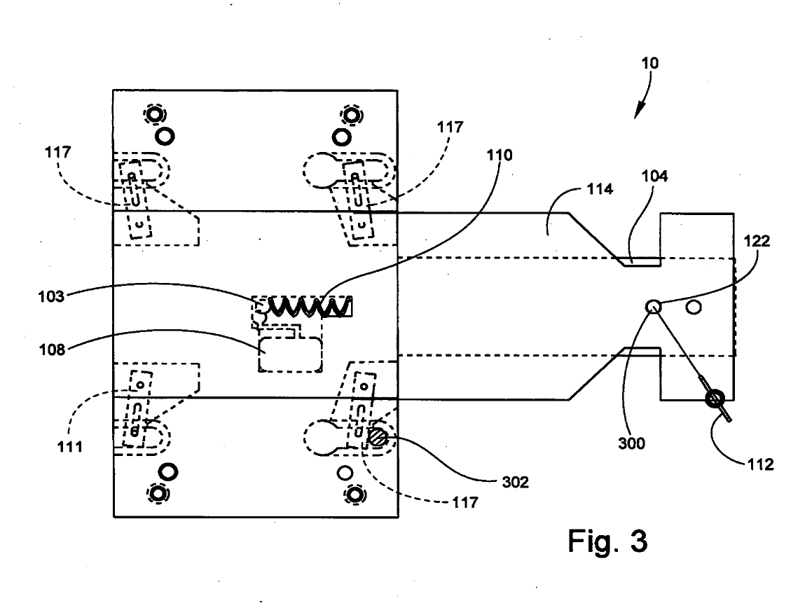

FIG. 3 illustrates the mounting base apparatus 10 in the closed position, in which the locking pin 112 engages two adjacent holes 300 in slider plate 114 and hole 122 in connecting plate 104. The slider plate return spring 110 is in the extended position, and stop pin 103 is engaging the limit switch 108. This position of the limit switch 108 can close (or open) an electrical circuit to allow the engine (not shown) to run. All four links 117 are pivoted into the closed position, positively engaging the bodies of the four implement-mounting studs (three are not shown). The body of one of these implement-mounting studs (516 shown on FIG. 5) is shown at in FIG. 3 at reference numeral 302.

As shown in FIG. 4, during the mounting operation, the large head of the implement-mounting stud passes up through a recess 400 in the bottom plate 106, then a recess 402 in the connecting plate 104, and then a recess 404 in the support plate 102. Recess 406 is the elongated recess for the body of the implement-mounting stud as the mounting base apparatus 10 is slid into position. Recess 404 is the elongated recess for the head of the implement-mounting stud as the mounting base apparatus 10 is slid into position.

FIG. 5 illustrates the motion used to connect a power shifter assembly 525 to an implement assembly 500 via the mounting base apparatus 10. While the partial implement shown in FIG. 5 has elements of a walk-behind leaf blower for illustration purposes, the implement assembly 500 is not so limited. The implement assembly 500 can be a variety of tools or implements such as a generator, pressure washer, de-thatcher, core aerator, chipper-shredder, snow thrower, etc. In the illustration of the implement assembly 500 shown in FIG. 5, a blower housing 504 contains a blower impellor blade 506 that is semi-permanently mounted to a spindle that is mounted upon bearings within an auxiliary spindle assembly 512. The auxiliary spindle assembly housing is semi-permanently attached to the blower housing 504 with auxiliary spindle assembly mounting bolts 520. Its spindle (not shown) is the actual torque-transmitting, intermediate member between the engine 502 and the work piece, in this case the blower impellor blade 506, which is fixably mounted with set screw 522. This spindle (not shown) supports the blower impellor blade 506 at rest (in the absence of the engine) and while active.

An implement engine mounting plate 503 accommodates four implement-mounting studs 516. While a variety of functional geometries can be employed in the implement-mounting studs, the implement-mounting studs 516 shown in FIG. 5 are commercially available shoulder screws. Such shoulder screws have heads larger than their bodies—which are machined to a precise diameter and length. Angle brackets 518 can be attached permanently or semi-permanently to the implement engine mounting plate 503, and the blower housing 504 in order to hold the blower housing 504 and implement-mounting plate 503 rigidly together.

The power shifter assembly 525 (abbreviated PSA) in this illustration comprises a flexible coupling hub 508A, to which is shown loosely attached, such as by screw, the accompanying elastomeric element 510, which transmits torque from an engine 502 to the implement assembly 500. Engine mounting bolts 514 can be used to fasten the engine 502 in a semi-permanent manner to the mounting base apparatus 10.

An engine, thusly attached to the mounting base apparatus 10 and with the flexible coupling elements 508A and 510 attached to its output shaft, is ready for use on an implement. In accordance with this embodiment of the invention, the implement is to be equipped with implement-mounting studs 516 and flexible coupling element 508B, which is attached to the spindle in the auxiliary spindle assembly 512, in order to receive torque transmitted from an engine equipped in this manner. This auxiliary spindle assembly 512 also serves to support any implement work piece or transmission element in the absence of an engine.

Where this style flexible coupling is used, the rubber element 510 can be attached individually at each implement fastened to the flexible coupling hub 508B, rather than at the engine-mounted flexible coupling hub 508A as shown in FIG. 5. In this alternative embodiment, the rubber element 510 would be sized to not transmit the full torque of the engine, but rather to transmit only some smaller torque, in order to limit the torque transmitted to any low-torque implement, for reasons of safety or durability. Such an embodiment, may be of interest for example on such an implement as a power edger that may require only three horsepower, being powered (in this power shifter system) by a larger engine, such as a 5.5 horsepower engine. Derating the rubber element 510 specifically for the implement, in this case, would prevent excessive torque from being transmitted to a sensitive implement, such as an edger

Referring now to FIG. 5, the power shifter assembly 525 is attached to the implement assembly 500, through the use of the mounting base apparatus 10, in order to power it. Initially, the mounting base apparatus 10 is set to the “open” position. In this position the power shifter assembly 525 can be either removed from the implement assembly 500, or placed onto a different implement prior to being locked into the “closed” position, at which point the engine is ready to be operated. As shown in FIG. 2, the “open” position is reached by pulling the slider plate 114 against the force of slider plate return spring 110 backward into the “open” position and locking it conveniently in the open position by inserting locking pin 112 into the two, adjacent plate holes 210 and 120.

As shown in FIG. 5, the power shifter assembly, thus prepared, is then manually manipulated down (along Path 1) onto the implement-mounting studs 516, and over (along Path 2) which couples the elements of the flexible couple 508A, 510, and 508B, thereby completing the torque path by which the engine powers the implement 500. The geometry of the implement assembly 500 is designed to provide the clearances needed to manipulate the power shifter assembly 525 freely into place and to align and couple the elements of the flexible coupling. Once the power shifter assembly 525 is in place on the implement assembly 500, the locking pin 112 is manually pulled out, which allows the slider plate return spring 110 to move the slider plate 114 forward, pivoting links 117 on their dowel pins 113, thereby closing the links 117 snugly against the bodies of the implement-mounting studs 516, as shown in FIG. 3. To positively secure the power shifter assembly 525 to the implement assembly 500, the locking pin 112 is then pressed into the two aligning holes 300 and 122 which pass through the connecting plate 104 and the slider plate 114.

In operation, the natural position of the slider plate return spring 110 works to close the mounting base apparatus 10, thereby acting also as a safety mechanism in the event the locking pin 112 is unexpectedly lost. Also, the limit switch 108 is acted upon by the stop pin 103 which is pressed-into the slider plate 114. Therefore, the limit switch 108 can sense whether the mounting base apparatus is fully locked or not. This limit switch 108 can be wired (not shown) into the ignition system of the engine 502, to prevent the engine from running if the mounting base apparatus 10 is not in the fully closed position.

In many implements, the throttle position (engine speed) is set directly on the engine during operation. In implements requiring the use of a throttle cable, provision for quick detachment and attachment of such a cable can be by such a means as a quick detachable ball joint rod end.

Another preferred embodiment of a mounting base apparatus and power shifter assembly is illustrated in FIG. 7, and shown generally at reference numerals 70 and 725, respectively. Advantages of the power shifter assembly 725 include its simplicity and low cost. As shown in FIG. 7, the engine 502 equipped with flexible coupling half 508A and rubber element 510 is bolted to a mounting base apparatus 70 with engine mounting bolts 514. Also attached to the mounting base apparatus 70 is the limit switch 108, which is wired into the engine's ignition system.

The mounting base apparatus 70 is slightly larger in “footprint” than the mounting base of the engine, with thickness sufficient to hold threads for engine mounting bolts 514, approximately ⅛″ to ¾″ thick. The mounting base apparatus 70 has recesses 706 that are engaged by ball detents 716, which are screwed into a pair of forward mount brackets 702A. Four such mount brackets 702A and 702B are semi-permanently attached to the implement-mounting plate 503 with bracket mounting bolts 714. A mount stop bracket 712 is also bolted to the implement-mounting plate 503 with bracket mounting bolts 714. The two rearward mount brackets 702B have through-holes for locking pins 112. Mounting recesses 710 clear the two rearward mount brackets 702B to greatly shorten the travel required to engage the rubber coupling element 510. This small travel required to seat the power shifter assembly 725 facilitates manipulation of the engine and the usefulness of this mounting system, due to the minimal clearances required to operate it.

Similar to the previous embodiment of the power shifter assembly 525, the power shifter assembly 725 is engaged by the mounting elements 702 to affect the quick attachment and quick disconnection of an engine to a power implement. Initially, with locking pins 112 removed, the power shifter assembly 725 is manually lowered into mounting position along Path 1, then pushed into coupling engagement position along Path 2. In order to make this “seating” travel Path 2 very short, recess 710 is provided to clear the rear mount brackets 702B during the lowering Path 1. In the properly seated position of rubber coupling element 510 engagement, the ball detents 716 engage the recesses 706 in the mounting base apparatus 70, and the limit switch 108 changes status to either closed or open, in order to enable the engine's ignition system. A contact element of the limit switch 108 bears against the mount stop bracket 712 thereby acting as a safety device, disabling the engine's ignition unless the mounting base apparatus 70 is in the fully seated position with respect to the mount stop bracket 712. To fixably retain the power shifter assembly 725 in position on the implement, locking pins 112 are inserted through aligning holes 708A and 708B. Aside from any throttle considerations, this completes the attachment of the power shifter assembly 725 to an implement.

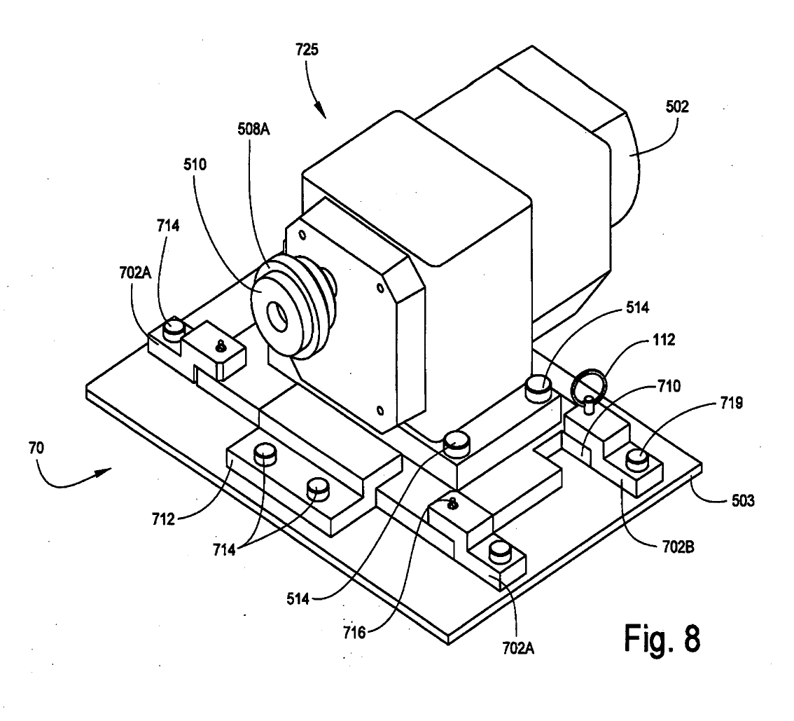

FIG. 8 illustrates the power shifter assembly 725 seated and locked in position for machine operation. The recess 710 which clears rear mount bracket 702B is shown as it appears in the locked position. The mounting base apparatus 70 and mount brackets 702 may be made from steel or other suitable material.

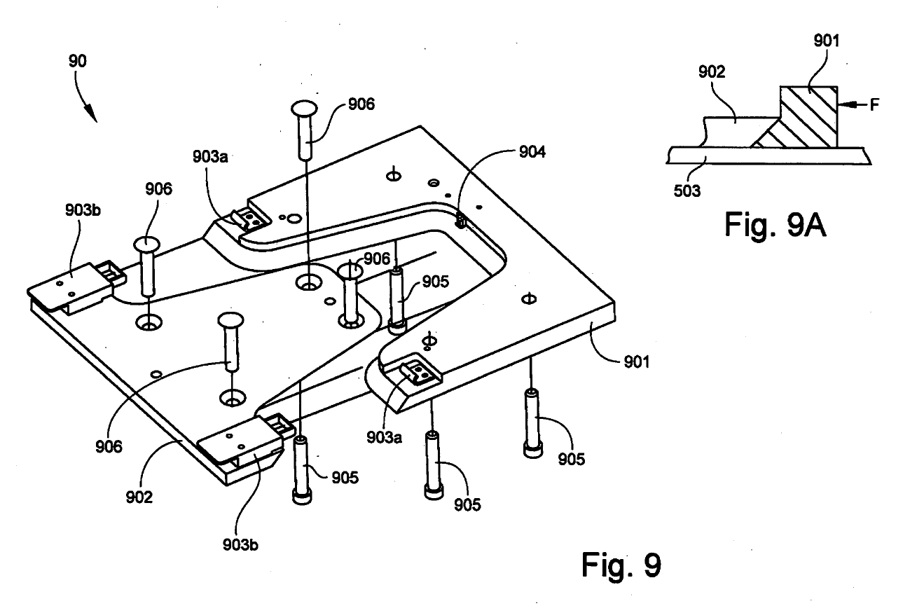

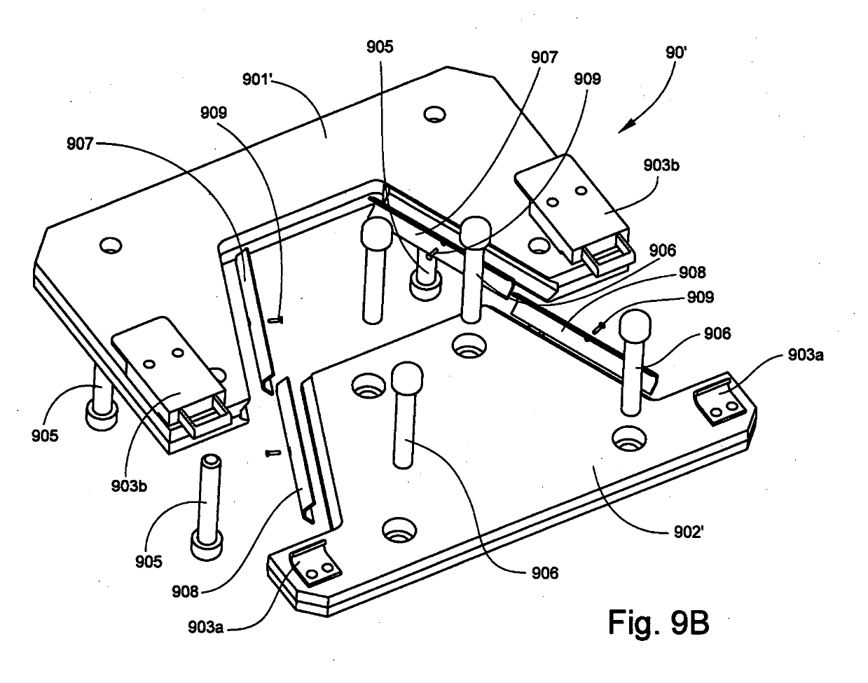

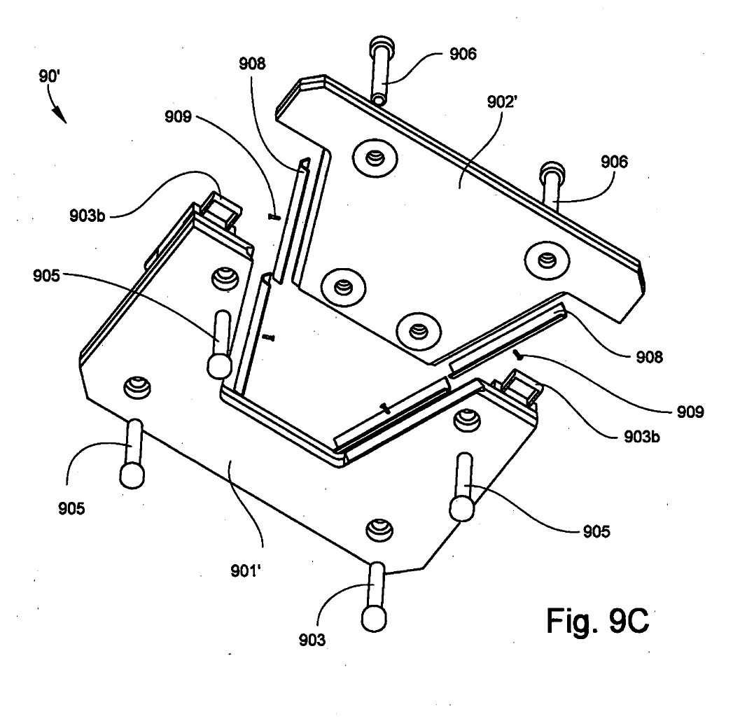

A mounting base apparatus according to yet another preferred embodiment of the invention is illustrated in FIGS. 9 and 10, and shown generally at reference numeral 90. A base mounting plate 902 is fastened to the rigid, flat implement engine mounting plate 503 with bolts 906. The engine 502 is attached to an engine support plate 901 with bolts 905. As shown in FIG. 9, the mounting plate 902 extends outwardly, and the support plate 901 is recessed for complementary engagement with the mounting plate 902. The materials for the base mounting plate 902 and the engine support plate 901 are sufficiently hard, strong and wear resistant to withstand the heat and operating forces of such an engine mounting system. The base mounting plate 902 may be made from steel, aluminum, appropriate plastics, and/or other suitable materials. For example, the thickness of plate 901 in aluminum may be approximately ⅝″ and the thickness of plate 902 in steel may be approximately ⅜″.

As a safety feature, a limit switch 904 can be mounted to engine support plate 901 with its striker protruding through a recess in plate 901, so as to engage the contour of the base mounting plate 902 when the engine support plate 901 is in the fully seated position. This limit switch 904 is wired into the ignition of an engine (not shown) to stop the engine from running should engine support plate 901 become disengaged from base mounting plate 902 by a small amount, even 1-2 mm. Latches 903 can be attached with fasteners such as screws such that the latch catch 903a is attached to the engine support plate 901 in a position adjacent to the latch 903b which is attached by fasteners such as screws to base mounting plate 902.

FIG. 10 shows a power shifter assembly 1000 in conjunction with a corresponding implement assembly 1002. FIG. 10 illustrates how the power shifter assembly 1000 would separate from the implement assembly 1002. The geometry of the engine support plate 901 and base mounting plate 902 with respect to each other is such that, when drawn together by the force of latches 903, the engine support plate 901 is rigidly constrained in the X, Y, and Z directions by base mounting plate 902 to affect strong, clearance free mounting of the engine to the implement assembly 1002. The geometry of the two plates together in conjunction with the placement and geometry of the auxiliary spindle assembly 512 ensure that the resulting position of engine output shaft 604 and auxiliary spindle assembly 512 are correctly aligned and positioned to facilitate proper function of a flexible coupling, such as a jaw-type coupling 1003 (or some other type of coupling in the same position as 1003) when latches 903 are drawn closed. Auxiliary spindle assembly 512 in this embodiment is comprised of a machined, cast metal housing that can be semi-permanently mounted to the implement engine mounting plate 503.

A shaft mounted on bearings is installed into this housing, as shown in FIG. 10. In such a configuration, the auxiliary spindle assembly 512 is capable of transmitting torque through its rotating shaft between engine and load, as well as withstanding the forces acting upon such an intermediate shaft arrangement. The engine half of this jaw-type coupling along with the elastomeric spider 1003b engages the implement half of the coupling 1003a to transmit torque. Torque may be transmitted directly through a coupling as shown, or a clutch assembly (not shown) to allow some load-balancing rotational slippage during torque spikes and to affect starting and stopping the machine as a function of engine speed. Base mounting plate 902 is shown semi-permanently attached to the implement engine mounting plate 503. The engine 502 can be semi-permanently attached to the engine support plate 901.

The wedging action of latching force “F” on plate 901 with respect to plate 902 forces engine support plate 901 firmly down into contact with implement engine mounting plate 503, as shown in FIG. 9A. An alternative mating geometry may take the form shown in FIG. 10A, where latching force “F” on plate 901 is in reaction solely with plate 902, without reaction from another plate or surface. Another alternative mating geometry is shown in FIG. 10B in which the force of the wedge profile caused by latching force “F” is solely resolved by plate 902. Either of these geometries may alternatively be round, as shown in FIG. 10C. This geometry need not be continuous, as in the embodiment of FIG. 9, but rather may be intermittent along the mating surfaces, to allow sufficient reacting force as required by the application.

The interface geometry on plates 901 and 902 may be identically conforming to achieve a clearance free fit when the two contours are drawn together. Alternatively, they may be slightly non-conforming to provide a slight interference fit, for example where the wedge angle (or the radius) on plate 901 would be less than the wedge angle (or the radius) on mounting plate 902.

An alternative embodiment of the invention is illustrated in FIGS. 9B and 9C, and shown generally at reference numeral 90′. The mounting base apparatus 90′ is substantially similar to the previously described mounting base apparatus 90, except that it utilizes a different geometry for the support plate 901′ and mounting plate 902′, as shown in FIGS. 9B and 9C. In addition, the mounting base apparatus 90′ has wear-resistant sections 907 attached to the edge of the support plate 901′ and wear-resistant sections 908 attached to the edge of the mounting plate 902′ where the support plate 901′ and the mounting plate 902′ interface. The wear-resistant sections can be attached using fasteners such as screws 909.

The power shifter assembly 1000 becomes usefully engaged with the implement assembly 1002 by manipulating the engine assembly in motions down (1) and over (2) as shown in FIG. 10, such that coupling or clutchhalves 1003a and 1003b align properly and the engine support plate 901 is brought into contact with the base mounting plate 902. It is permissible and expected that the operator will manually rotate the engine output shaft or the implement shaft slightly, to allow the coupling halves to engage as they are brought together. The gap along the direction of travel between plates 901 and 902 becomes very small, perhaps 2 mm, as engine support plate 901 is moved into engagement with base mounting plate 902. The latches 903 are then engaged and drawn together, which brings plates 901 and 902 into snug, clearance-free contact, firmly mounting the engine 502 in the power shifter assembly 1000 to the implement assembly 1002. Detaching the power shifter assembly is a reverse of this procedure. This cycle of releasing the power shifter assembly 1000 from one implement assembly 1002 and attaching it to another is very fast, and may be accomplished in as little as twenty seconds or less.

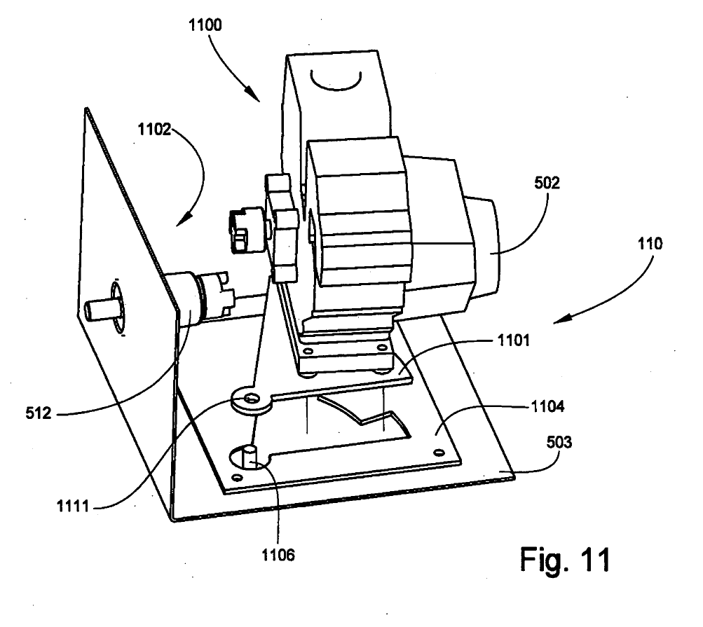

A mounting base apparatus according to yet another preferred embodiment of the invention is illustrated in FIG. 11, and shown generally at reference numeral 110. FIG. 11 illustrates how a power shifter assembly 1100 would separate from an implement assembly 1102. Auxiliary spindle assembly 512 is shown attached to a mounting surface at a right angle, which would be affected by some structure on an implement, as shown. While the auxiliary spindle assembly 512 in FIG. 11 is not free standing like the auxiliary spindle assembly 512 of FIG. 10, their function and operation are analogous, and the two may be effectively interchanged, depending upon machine structure. An engine support plate 1101 is shown attached to engine 502. A retaining plate 1104 is mounted on spacers (not shown) above implement engine mounting plate 503. A pivot pin 1106 is of slightly smaller outside diameter than the inside diameter of a pivot hole 1111.

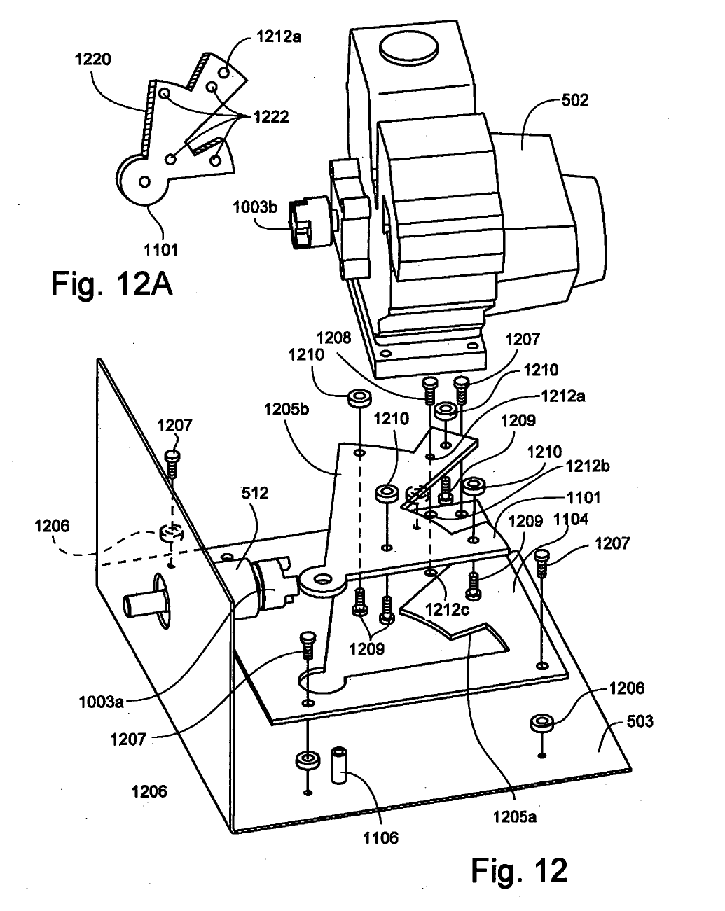

As shown in FIG. 12, an engine 502 is attached to the engine support plate 1101 atop engine mounting spacers 1210 with engine mounting bolts 1209. These engine mounting spacers 1210 are longer than the thickness of retaining plate 1104 so that the base of the engine 502 does not interfere with the pivoting motion of engine support plate 1101. This engine support plate 1101 is shaped in a profile 1205b to provide engagement areas in a matching but slightly larger profile 1205a in retaining plate 1104, when 1102 is plunged below retaining plate 1104 and pivoted some small angle counterclockwise with respect to the retaining plate 1104, on pivot pin 1106. This small angle may be five to ten degrees. Profile 1205a in retaining plate 1104 is slightly larger than profile 1205b in engine support plate 1101 in order to allow the support plate 1102 to pass freely down through this recess in plate 1104. The pivot pin 1106 is mounted rigidly to engine implement mounting plate 503.

As before, engine implement mounting plate 503 can be rigidly attached to the implement chassis or is part of the implement chassis. Retaining plate 1104 is bolted to engine implement mounting plate 503 with bolts 1207 atop spacers 1206. These spacers 1206 are the same length as or several thousands of an inch longer than the thickness of engine support plate 1101, such that the engine support plate 1101 is retained snugly under and by retaining plate 1104, when engine support plate 1101 is pivoted counterclockwise. Clearance holes 1212a and 1212b and threaded hole 1212c align when engine support plate 1101 is pivoted, allowing a thumbscrew 1208 to be installed, engaging all three plates.

This thumbscrew 1208 holds the engine mounting plate in this locked position. Materials and thickness of plates 1102 and 1104 are sufficiently hard and strong to mount the engine and resist wear. The plates 1102, 1104 can be made from materials such as aluminum, steel, or suitable plastic. The geometry of the plates 1102, 1104 and the pivoting motion into the “engaged” position is such that coupling or clutchhalves 1003a, 1003b are properly engaged so as to transmit torque between the engine and load. A limit switch (not shown) may be installed beneath the retaining plate 1104 and wired into the engine ignition to stop the engine for safety reasons should the power shifter assembly 1100 pivot out of the fully engaged position. The interference area 1220 by which retaining plate 1104 overlaps and therefore holds down the engine support plate 1101 is shown in FIG. 12A as hatching. The engine mounting holes in the engine mounting plate 1102 are shown as 1222. Clearance hole 1212a is shown outboard of engine mounting holes 1222 in FIG. 12A.

The pivot hole 1111 on power shifter assembly 1100 is lowered onto a pivot pin 1106 through the recess 1205a in the retaining plate 1104 in motion 1 as shown on FIG. 11. The power shifter assembly 1100 is then rotated counterclockwise into the engaged position per motion 2. At this point, the coupling halves 1003a and 1003b are also properly engaged and thumbscrew 1208 is installed, to hold the engine support plate 1101 firmly in position for operation. Disengagement of the power shifter assembly 1100 is a reverse of this procedure.

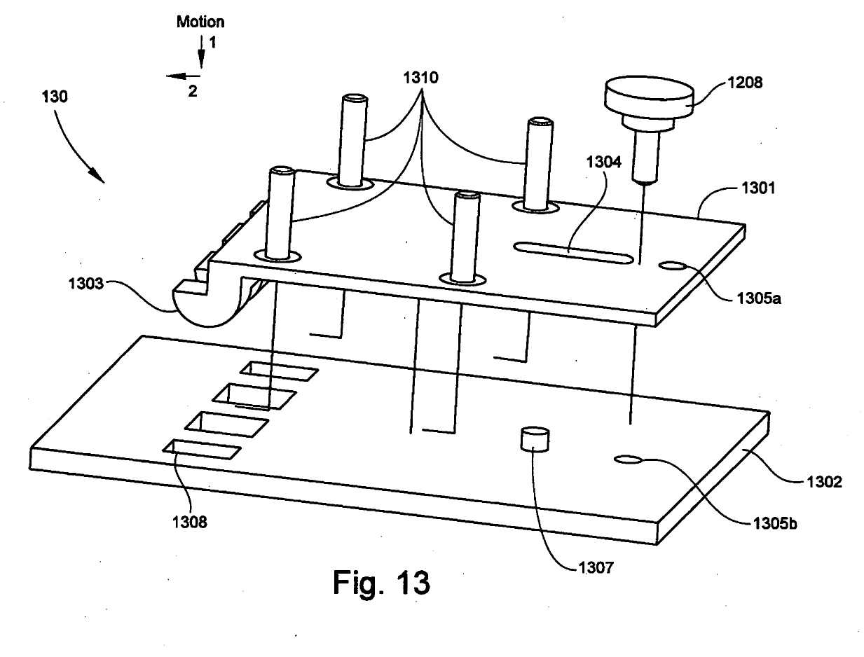

A mounting base apparatus according to yet another preferred embodiment of the invention is illustrated in FIG. 13 and shown generally at reference numeral 130. FIG. 13 shows the operation of an engine support plate 1301 as it would engage a specially made implement mounting plate 1302. FIG. 13 shows the mounting system only, without engine or auxiliary spindle housing, since these features have been thoroughly described in the previous embodiments and their function and purpose is analogous in this embodiment. The geometry of the fully engaged engine support plate 1301 is such as to ensure proper function of the coupling or clutch with respect to the engine and the auxiliary spindle housing. Material and thickness of these plates 1301, 1302 is of such metal or plastic sufficient to withstand the forces and temperature and wear typical of such an engine mounting application. A limit switch (not shown) that is acted upon by the mounting plate 1302 may be attached to the support plate 1301 and wired into the ignition of the engine so as to prevent it from running should the engine support plate 1301 become even slightly separated from implement mounting plate 1302.

An engine (not shown) can be bolted to engine support plate 1301 using bolts 1310. The engine support plate 1301 has at least one interlocking member such as a plurality of shaped fingers 1303 that facilitate engagement with complementary interlocking means on the implement engine mounting plate 1302 such as a plurality of recesses 1308. The recesses 1308 in plate 1302 are just large enough to clear the shaped fingers 1303. In this particular embodiment, a large part of the mounting force is carried through the recesses 1308 in the implement mounting plate 1302. The engine support plate 1301 also contains an aligning slot 1304 and a clearance locking hole 1305a which aligns with threaded locking hole 1305b on implement mounting plate 1302. The plate 1302 is rigidly attached to the machine, or is part of the machine chassis. A thumbscrew 1208 engages the threaded hole 1305b. An aligning pin 1307 is fastened into the implement engine mounting plate 1302. Aligning slot 1304 is of a geometry so as to engage aligning pin 1307 for guidance through the entire sliding travel of the engine support plate 1301.

A power shifter assembly, in this embodiment equipped with an engine mounted to engine support plate 1301 is lowered in motion 1 onto the implement assembly such that fingers 1303 of the support plate 1301 protrude down through recesses 1308 of the mounting plate 1302 such that aligning pin 1307 can protrude up though aligning slot 1304. In motion 2, the power shifter assembly is slid laterally sideways in the direction of the engine output shaft (not shown) in order to engage a coupling or clutch as previously described. Once properly seated, the thumbscrew 1208 is installed, firmly locking the power shifter assembly into position on the implement. Disengagement is a reverse of this procedure.

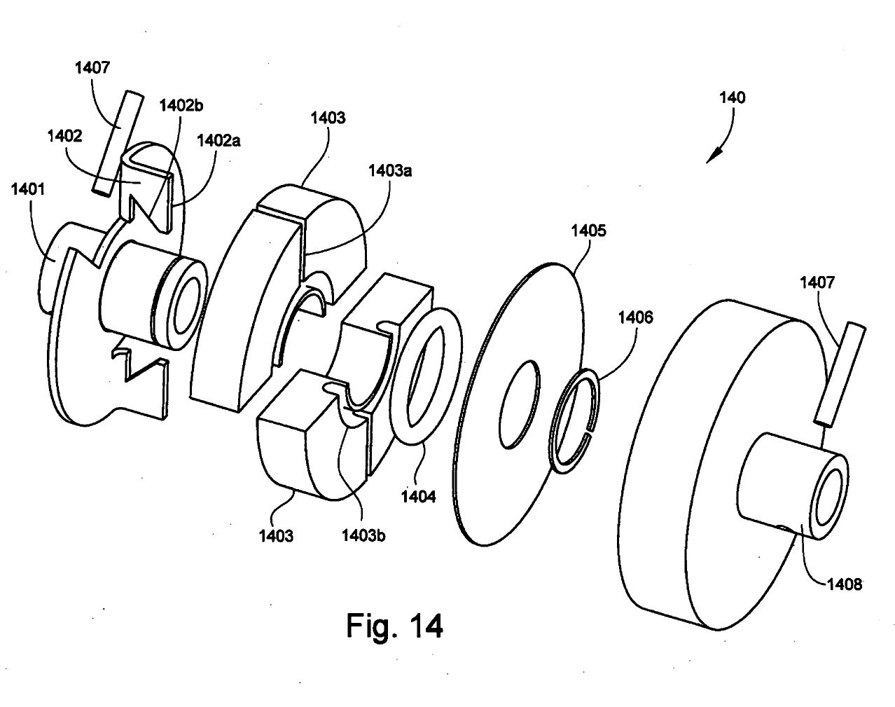

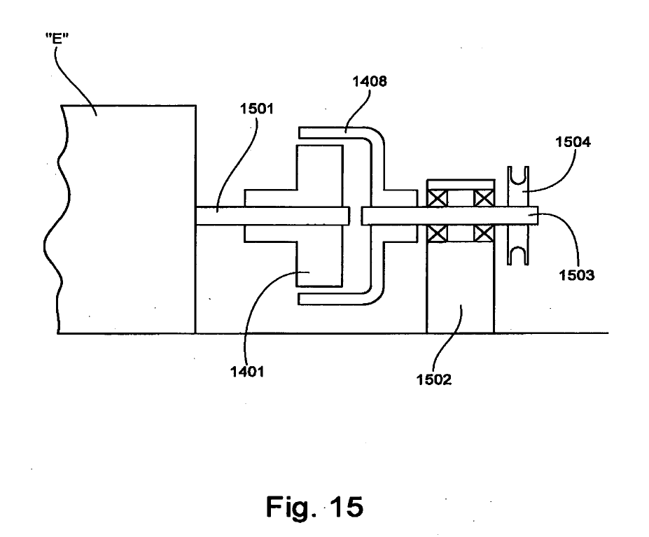

A clutch assembly according to a preferred embodiment of the invention is illustrated in FIGS. 14 and 15, and shown generally at reference numeral 140. A clutch center hub 1401 is semi-permanently installed to an engine output shaft 1501 of an engine “E” with clutch retaining pin 1407 or key with set screw (not shown). A clutch drive plate 1402 is permanently attached to clutch center hub 1401. A plurality of clutch shoes with hook profile 1403 are positioned against clutch drive plate 1402 with drive tab 1402a positioned in a specially formed recess 1403a. The drive tab 1402a includes a hook profile 1402b. A clutch garter spring 1404 is positioned within a garter spring slot 1403b and clutch closing plate 1405 is positioned onto this clutch subassembly to hold parts 1404 and 1403 onto the center hub 1401 and drive plate 1402. Clutch closing plate 1405 is retained in place with a clutch snap ring 1406. These components are mounted on the engine side of the clutch assembly 140.

The machine side of the clutch assembly 140 includes clutch drum 1408, which is semi-permanently attached to an auxiliary spindle 1502 with clutch retaining pin 1407 or key with setscrew (not shown).

Prior art clutch construction has been to assemble the mechanical components of a centrifugal clutch together into one assembly. In known prior art it is not feasible to rapidly draw the clutch drum rapidly away from an engine running at high speed in order to create a hazardous condition in which clutch shoes could fly out and cause injury or damage. In the present invention, however, a determined and misguided operator could achieve this dangerous condition of clutch separation with an engine running at high speed. In order to circumvent this danger of clutch shoes 1403 flying out, the specially formed recess 1403a is shaped in order to engage the drive tab 1402a with a mating hook profile in the event the clutch drum 1408 would be rapidly withdrawn for whatever reason.

One of ordinary skill in the art can understand that the invention provides a means by which a motor can be quickly attached and quickly detached from any number and a wide variety of power equipment implements. In the embodiments described above, the mounting base apparatus is semi-permanently mounted to the base of the engine, which enables the engine to then mount in a quick disconnect manner to an implement equipped for this purpose with an auxiliary spindle assembly and either implement-mounting studs or mount brackets.

Alternatively, the mounting base apparatus can be built right into the base of the engine by the engine manufacturer, eliminating the mounting base apparatus as an intermediate item—and incorporating it instead right into the engine assembly.

In another alternative embodiment, a mechanism can be built into the actual implement, and engage surfaces of the engine base, thereby also eliminating the mounting base apparatus as an intermediate item—and incorporating it instead right into the implement assembly.

In a preferred embodiment of the invention, the mounting base apparatus 10 grasps onto a plurality of implement-mounting studs for the purpose of attachment to the implement, using four implement-mounting studs 516. It is conceivable to use a different quantity of studs, or even just one. It is further anticipated that a different geometry (of implement mounting stud) may be used than the illustrated shoulder screw, including, but not limited to spheres, wedges, flats, or any other geometry that would enable positive attachment along with the positioning needs of the overall assembly.

Alternative methods of mechanical gripping or attachment include squeezing upon, screwing, expanding, contracting, engaging with a cam, suction, and even magnetic attraction. Any of these may be used to proper affect in additional, alternative embodiments of my invention. Further, any number of methods of achieving motion may be employed to provide a locking means, including but not limited to sliding, pivoting, turning, and a combination of motions. Mechanisms that may be used to impart such motion may include gears, chains, belts, cams, links, shafts, levers, or any combination thereof.

A spring element or elastomeric element or a combination of these, may be used to take up clearances created by machining tolerances, to ensure a clearance free or pre-loaded condition at the link 117 and implement-mounting stud 516 interface, and the like with respect to parts 704, 702 and 712. Similarly, various mating or closely mating but deliberately mismatched geometries at an attachment interface may be used to provide a low clearance or a clearance-free condition for a mounting mechanism. While a small amount of “play” in the interface between a mounting base apparatus and an implement assembly is not believed to be a functional problem in the present invention, there are alternative geometries that can mitigate this play. These geometries include, but are not limited to, such configurations as conical (cup in cone), triangular (wedge), circular (spherical), flat (planar) etc. Such geometries may be applied to either the shape of the overall mount interface between engine and implement, or to elements of the locking interface elements, or to both.

While the preferred and alternative embodiments of the present invention operate upon the concept of gripping onto (or by) a “positive” feature such as implement-mounting stud 516 and mount bracket 702, it is also feasible to provide a hole or shaped recess in the implement-mounting plate 503 and attach onto it instead, with elements that would protrude or emanate from a mounting base apparatus during a “closing” operation. For example, a finger gripper (eccentric or otherwise) or a spreader arrangement (similar to a commercial moly-bolt) or a cam type mechanism that could drop below the plane of an implement-mounting plate (or a recess therein) and then be actuated to clamp with sufficient force, could be used as a quick disconnect interface. If such a recess were a threaded hole, then using a bolt-type appendage as a fastening means and motivating it with rotational motion from a mounting base mechanism would serve to seat a mounting base apparatus firmly and quickly to an implement-mounting plate. As another example, if the implement-mounting plate 503 comprised a plate with several precisely located holes and the mounting base apparatus comprised a suction cup or a switchable magnet base (such as those well known in metal working) with nubs protruding to precisely engage these holes—this combination would also provide a strong, quick disconnect means to achieve the present invention.

Further, it is believed that an effective mounting interface between an implement plate and a quick disconnect mounting base may take the form of rigid plates with contoured, angled, or beveled surfaces that, when forced together (or apart) by a simple locking mechanism such as a cam or lead screw, would provide fast, strong, rigid connection.

While preferred embodiments of the invention described above feature an engine with a horizontal shaft, there is no such limitation to the present invention, which could also be used on vertical shaft engines as well by providing a recess to allow passage of the engine output shaft through the body of the device.

Simplifications to the embodiments shown are possible, while still retaining the basics of quick disconnect functionality. These simplifications include, but are not limited to, using fewer mount brackets 702, fewer links 117, fewer implement mounting studs 516, one fewer locking pin 112 (in power shifter assembly 725) and eliminating ball detents 716, stop mount bracket 712, limit switch 108, slider plate return spring 110, and also stop pin 103.

Additional embodiments entirely are achieved when an implement machine plate itself is equipped with the mounting base apparatus in order to attach to specially formed (or existing) holes or recesses in the base of an engine. The engine base may receive a dovetail type contour (or other geometry) in order to be gripped securely by an implement plate thusly equipped. For example, the preferred may simply be “reversed” so as to act upwardly, upon mounting studs bolted to the engine base.

The various embodiments of the present invention can provide a positive, safe means to attach a motor, such as a small internal combustion engine, to any number of outdoor power equipment implements, such as a snow thrower, chipper-shredder, tiller, de-thatcher, core aerator, generator, log splitter, edger, leaf blower, compressor, paint sprayer, water pump, pressure washer, etc. Since more types of implements may be required for a given homeowner task or rental or landscaping business than is the need to operate them simultaneously, it is therefore advantageous to purchase and maintain fewer engines than implements. The various embodiments of the mounting base apparatus 10, 70, 90, 110, 130 as part of the power shifter assemblies 525, 725, 1000, 1100 in conjunction with an implement assembly 500,1002,1102 equipped to accommodate this mounting system achieve the increased functionality and versatility of conveniently swapping a singular engine onto a variety of outdoor power equipment implements and types.

Because the present invention allows an engine to be very quickly and conveniently disconnected from one implement and mounted onto another, one advantage of the invention is the ability to use one engine on a multiplicity of implements. This carries with it advantages in ownership, service, economy and in marketing as follows. Additional benefits are derived in other applications, such as with electric motors and their related equipment.

For an owner requiring several implements, only one engine need be maintained, which pertains to servicing spark plug, oil, air cleaner and/or oil filter. Gasoline engines that are operated regularly experience a continuous supply of fresh fuel. However, when fuel is allowed to sit for extended periods (months) it breaks down and at worst will require disassembly service of the carburetor to restore proper operation. For this reason small engines must generally be “run dry” at the end of the season to forestall this problem. Such service is not necessary when a single engine is used year 'round, during warm weather on, for example, a chipper-shredder, a generator, a leaf blower, a de-thatcher, an aerator, a tiller, etc. and continues in service during the cold weather, on, for example, a snow thrower.

Servicing a quickly-detachable engine is more convenient for the technician, as he or she can, using the present invention, disconnect the engine from the implement and mount it quickly and conveniently onto a servicing stand equipped with this mounting system, in an optimum position, in a well-lit work area. This spares the technician from crouching over an implement on the floor because it's heavy and awkward to lift onto a crowded workbench—while gaining only limited access to the engine for servicing.

Because the engine typically is by far the most expensive component of a power implement, a significant savings can be achieved by the owner of multiple implements equipped for use with the present invention. The more implements they require, per engine, the greater the savings realized. This becomes quite significant, for example, for the owner of an equipment rental or a landscape business. For example, a business owner knowing that client rental or seasonal demand is for some thirty power implements of various types at any one time, prior to the present invention the business owner would be required to purchase a variety of perhaps fifty implements, each with its own engine, and sustain the maintenance cost of these fifty engines. With the present invention, however, this business owner might decide that he or she can purchase the fifty implements required plus perhaps only thirty engines for perhaps the price of forty prior art style implements, and have to service only thirty engines. On a smaller scale, a homeowner might purchase five implements and one engine for the price of three implements, and have to service only one engine. Furthermore, maintaining fewer engine types reduces the cost of inventory required in the service department.

A market advantage can be gained by manufacturers who incorporate the present invention into their equipment. For example, an implement manufacturer with some market share in tillers, may also gain market share in snow throwers and blowers—because once a user has purchased an engine or complete implement compatible with the present invention, it is likely they will want to enhance the value of their purchase and acquire other implements so equipped. For the engine manufacturer with less-than-dominant market share, equipping their engines with the present invention may increase their sales volume. For the engine or implement manufacturer with dominant market share, equipping their engines or implements with the present invention may serve to protect their dominant market position. If the present invention were “built into” the base of an engine, not only might overall production costs to equip an engine with the present invention be reduced, but an engine model designed for such use would also eliminate the need for an implement-mounting boss 600, slightly reducing engine manufacturing cost.

Fuel economy, in certain instances, is another advantage of the present invention. In recent years, marketing trends have pushed up engine power on implements, in much the same way auto-makers have increased horsepower to attract customers. In many cases this additional power and the accompanying increase in fuel consumption are not actually required on a power implement. Therefore, if the engine equipped with a mounting base apparatus of the present invention is smaller than the average size of the group of engines it replaces, it may provide superior overall fuel efficiency. If global manufacturing of net fewer engines is a result of the present invention, energy and carbon emissions will be reduced due to the reduced amount of melting needed for cast engine components, and petroleum will be saved due to the reduced engine plastics that will be required. Other such energy and carbon savings are conceivable from a reduced manufacturing “footprint.”

Superior implement reliability can be achieved, given the ease with which a backup engine can be substituted quickly for a failed one. Other advantages may be realized by those in the art.

A mounting base apparatus and methods of using same are disclosed above. While specific embodiments of the present invention have been described above, various modifications thereto can be made without departing from the spirit and scope of the invention. Accordingly, the foregoing description of the preferred embodiments of the invention and the best mode for practicing the invention are provided for the purpose of illustration only and not for the purpose of limitation—the invention being defined by the claims.

What is claimed is:

1. A mounting apparatus for supporting a motor and releasably attaching to a power implement, the mounting apparatus comprising:
(a) at least one support plate for receiving the motor thereon and movably connected to at least one latching member;
(b) a connecting plate connected to the at least one support plate and having at least one opening for receiving a power implement connecting member and the at least one latching member therethrough; and
(c) a slider plate movably connected to the at least one latching member and adapted for sliding movement relative to the at least one support plate whereby the slider plate can move between a locked position, wherein the latching member engages the power implement connecting member to connect the mounting apparatus to the power implement, and an open position, wherein the latching member is disengaged from the power implement connecting member and the mounting apparatus is removeable from the power implement.

2. A mounting apparatus according to claim 1, wherein the mounting apparatus includes restoring means for returning the slider plate from the open position to the locked position.

3. A mounting apparatus according to claim 2, wherein the restoring means comprises a spring contacting the connecting plate and positioned within an opening of the connecting plate, the spring being further in contact with a stop pin attached to the slider plate.

4. A mounting apparatus according to claim 1, wherein the mounting apparatus includes securing means for releasably securing the slider plate in the open position.

5. A mounting apparatus according to claim 4, wherein the securing means comprises a locking pin inserted through at least one opening on the slider plate and at least one opening on the connecting plate.

6. A mounting apparatus according to claim 1, wherein the mounting apparatus includes interrupting means for interrupting the motor when the slider plate is not in the locked position.

7. A mounting apparatus according to claim 6, wherein the interrupting means comprises a limit switch attached to the connecting plate and electrically connected to the motor.

8. A mounting apparatus according to claim 1, wherein the power implement connecting member comprises a mounting plate attached to the power implement and capable of receiving the mounting apparatus thereon.

9. A mounting apparatus according to claim 1, wherein the at least one support plate is pivotally connected to the at least one latching member, and further wherein the slider plate is pivotally connected to the at least one latching member.

10. A mounting apparatus according to claim 1, wherein the at least one latching member includes a slot and is adapted for sliding movement relative to the at least one support plate.

11. A mounting apparatus according to claim 1, wherein the at least one opening comprises a recess.

12. A mounting apparatus for supporting a motor and releasably attaching to a power implement, the mounting apparatus comprising:
(a) a first outer plate for receiving the motor thereon;
(b) at least one support plate connected to the first outside plate, and moveably connected to at least one latching member;
(c) a connecting plate connected to the at least one support plate and having at least one opening for receiving a power implement connecting member and the at least one latching member therethrough;
(d) a slider plate movably connected to the at least one latching member and adapted for sliding movement relative to the at least one support plate whereby the slider plate can move between a locked position, wherein the latching member engages the power implement connecting member to connect the mounting apparatus to the power implement, and an open position, wherein the latching member is disengaged from the power implement connecting member and the mounting apparatus is removeable from the power implement; and
(e) a second outer plate connected to the connecting plate and having at least one opening substantially aligned with the at least one opening of the connecting plate for receiving the power implement connecting member therethrough.

13. A mounting apparatus according to claim 12, wherein the mounting apparatus includes restoring means for returning the slider plate from the open position to the locked position.

14. A mounting apparatus according to claim 12, wherein the mounting apparatus includes securing means for releasably securing the slider plate in the open position.

15. A mounting apparatus according to claim 12, wherein the mounting apparatus includes interrupting means for interrupting the motor when the slider plate is not in the locked position.

16. A mounting apparatus according to claim 12, wherein the at least one latching member has a slot and is adapted for sliding movement relative to the at least one support plate.

17. A mounting apparatus for releasably securing a motor to a power implement, the mounting apparatus comprising:
(a) a support plate for receiving the motor thereon and having at least one interlocking member; and
(b) a mounting plate connected to the power implement and having complementary interlocking means for engaging the interlocking member of the support plate to releasably secure the support plate to the mounting plate.

18. A mounting apparatus according to claim 17, wherein a tapered edge of the support plate is adapted to mate with a complementary tapered edge of the mounting plate when the support plate is releasably secured to the mounting plate.

19. A mounting apparatus according to claim 17, wherein a concave edge of the support plate is adapted to mate with a complementary convex edge of the mounting plate when the support plate is releasably secured to the mounting plate.

20. A mounting apparatus according to claim 17, wherein the at least one interlocking member comprises at least one latching member and the complementary interlocking means comprises at least one complementary latching member adapted to receive and releasably secure the at least one latching member.

21. A mounting plate according to claim 17, wherein the support plate and the mounting plate are shaped for complementary engagement.

22. A mounting apparatus according to claim 17, wherein the at least one interlocking member comprises a plurality of fingers extending downwardly from the support plate, and the complementary interlocking means comprises a plurality of recesses for receiving the fingers, whereby engagement of the fingers in the recesses connects the support plate to the mounting plate.

23. A mounting apparatus according to claim 17, wherein the at least one interlocking member comprises a first opening, and the complementary interlocking means comprises a lower section mounted on the mounting plate and an upper section extending above the lower section and having a second opening for aligning with the first opening where the interlocking member is positioned below the upper section such that a fastener can be positioned through the first and second openings to attach the support plate to the mounting plate.

24. A mounting apparatus according to claim 17, wherein the support plate has a perimeter defining a distinct shape, and the interlocking means comprises a platform mounted on the mounting plate and having an opening defining a shape substantially similar to the shape of the support plate perimeter for receiving the support plate therein and maintaining the support plate in a stationary position.

25. A mounting apparatus according to claim 24, wherein the interlocking means comprises a fastening member mounted on the mounting plate and the interlocking member comprises an opening proximate to the perimeter of the support plate for receiving the fastening member therethrough.

26. A clutch assembly for use with an engine and a power implement comprising:
(a) an engine output shaft operatively connected to the engine;
(b) a clutch hub mounted on the engine output shaft;
(c) an intermediate shaft operatively connected to the power implement;
(d) a clutch drum connected to the intermediate shaft and operatively connected to the clutch hub, wherein the engine output shaft is disconnected from the intermediate shaft whereby the power implement is removable from the engine output shaft.

27. A clutch assembly according to claim 26, further comprising at least one clutch shoe having a substantially hook profile.
